(19) United States
(12) Patent Application Publication
(10) Pub. No.: US 2006/0046561 A1
(43) Pub. Date: Mar. 2, 2006

(54) Retractable cord assembly

(75) Inventors: Yai Man Raymond Lam, Hong Kong (HK); Jeffrey Wade, Hong Kong (HK)

Correspondence Address: LEYDIG VOIT & MAYER, LTD, 700 THIRTEENTH ST. NW, SUITE 300, WASHINGTON, DC, 20005-3960, US

(73) Assignee: Main Power Electrical Factory Ltd., Kwun Tong (HK)

(21) Appl. No.: 11/211,090

(22) Filed: Aug. 25, 2005

(30) Foreign Application Priority Data
Aug. 27, 2004 (GB) 0419120.1

(51) Int. Cl. H01R 13/72

(52) U.S. Cl. 439/501

(57) ABSTRACT

Retractable cord assembly has a power cord for supplying power to an electrical appliance and a plug top with electrical pins connected to one end of the cord for connection with a wall outlet. The power cord is coiled on a spring-loaded spool within the plug top and is extendable from the plug top. The spring-loaded spool provides a retracting force to retract the power cord back within the plug top.

### BACKGROUND OF THE INVENTION

1. Field of the Invention

The present invention relates to cord assemblies for domestic electric appliances and in particular to retractable cord assemblies.

2. Background Information

Mains powered domestic electric appliances require a power cord for connecting to an electrical outlet/wall socket. The power cord is usually quite long, i.e. several metres. It is usual for the power cord to be wrapped around the appliance for storage and this causes twists and spirals in the power cord which can result in breakage of internal conductors. Also, excess power cord can be inconvenient and even dangerous during use of the appliance. Excess cord can swing and get caught during movement of the appliance. Additionally, the cord will hang down when the appliance is placed on a table or ironing board for example. This hanging cord can be caught or pulled causing the appliance to fall.

### SUMMARY OF THE INVENTION

It is an object of the present invention to overcome or substantially ameliorate at least one of the above problems and/or more generally to provide improved cord assembly that provides the public with a useful alternative.

There is disclosed herein a retractable cord assembly having a power cord for supplying power to an electrical appliance and a plug top coupled to the power cord for connecting the power cord to an electrical wall outlet, the plug top comprising a housing having electrical pins for electrical connection with electrical connectors of the electrical wall outlet and a spring-loaded spool on which the power cord can be coiled within the plug top housing, and wherein the power cord is extendable from the housing and the spring-loaded spool provides a retracting force to retract the power cord back within the housing.

Preferably, the plug top further comprises a brake for maintaining the power cord in the extended position and a brake release for releasing the brake so that the retracting force retracts the power cord back within the housing.

Preferably, the brake release comprises a button located on the plug top housing.

Further aspects of the invention will become apparent from the following description.

### BRIEF DESCRIPTION OF THE DRAWINGS

An embodiment of the present invention will now be described by way of example and with reference to the accompanying drawings in which:

FIG. 1 is a retractable cord assembly according to the invention,

FIG. 2 is a sectional view of the cord assembly spool, and

FIG. 3 is a domestic electric appliance, specifically but not exclusively an iron, using the retractable cord assembly.

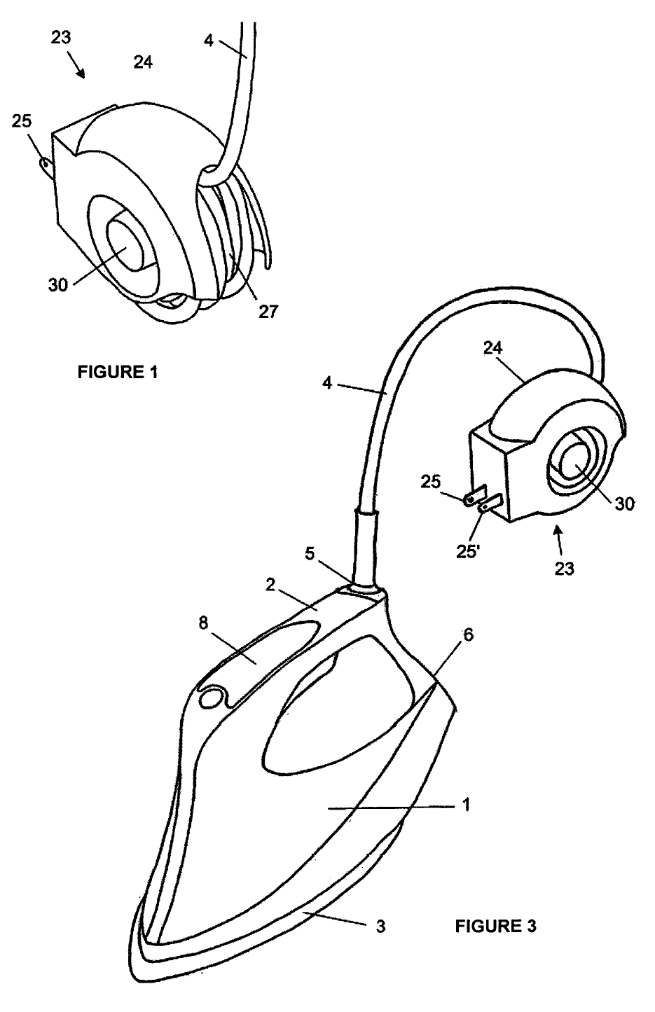

### DETAILED DESCRIPTION OF THE DRAWINGS

In the accompanying drawings there is depicted a retractable cord assembly for use with a domestic electric appliance, for example iron 1. The cord assembly comprises a power cord 4 for supplying power to an electrical appliance 1 and a plug top 23 coupled to the power cord 4 for connecting the power cord to an electrical wall outlet. The power cord 4 is coiled on a spring-loaded spool 26 within the plug top 23 and is extendable from the plug top 23. The spring-loaded spool 26 provides a retracting force to retract the power cord 4 back within the plug top 23. The plug top 23 connected to the cord 4 for connecting the appliance 1 to the power outlet/wall socket includes a housing 24 provided with electrical pins 25, 25′ extending from one end. The pins 25, 25′ are of a known type for electrical connection with the electrical connectors of the power outlet/wall socket. Positioned within the housing 24 is a rotational spool 26 on which the cord 4 is stored. The cord is stored neatly in a coil 27 to prevent twists.

A coiled torsion spring 28 is coaxially coupled to the spool 26 for storing retraction energy when the cord 4 is extended from the spool 26. A brake 29 with release button 30 maintains the spool 26 in the desired position when the cord 4 is extended. When the release button 30 is pressed the spring 28 provides a retracting force to rotate the spool 28 to rewind the cord 4 to the stored position 27.

In use, a sufficient length of cord 4 is extended from the spool 26 for use of the iron. Excess cord is housed neatly and safely inside the plug housing 24 against the power outlet/wall socket.

Power is coupled from the electrical pins 25, 25′ to the cord 4 via a pair of continuous conductive slip-rings 31, 32 located on the spool 26 and a pair of conductive contacts 33, 34 located with the housing 24. The contacts are coupled to the pins 25, 25′ and the slip-rings 31, 32 are coupled to the power cord 4.

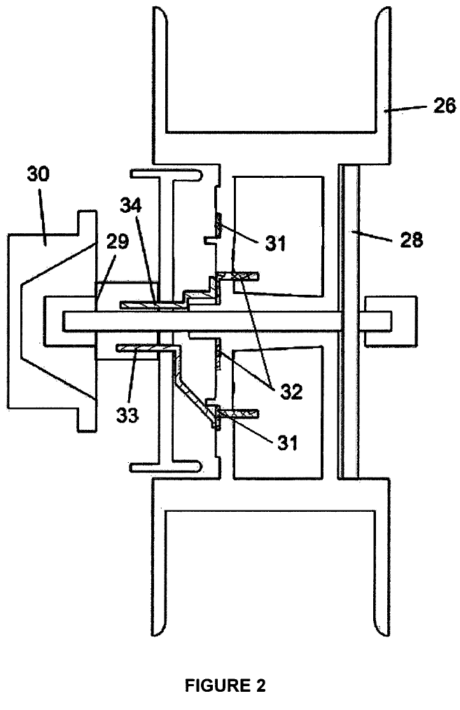

A typical use of the cord assembly with a domestic electric appliance is shown in FIG. 3. There an electric iron comprises a housing 1 having a handle 2 integrally formed at an upper part thereof and a heat plate, or soleplate, 3 positioned at a lower part thereof. A heating element is positioned with the soleplate 3 for heating it. The power cord 4 is connected to the base 5 of the handle 2 for connecting the iron to the power outlet/wall socket (not shown). A stand, or foot, 6 is provided proximate the base 5 of the handle 2 for allowing the iron to rest in an upright position during heating or pressing rest periods. The above configuration is substantially as known and may include an internal water tank, and a water jet/steam outlet 7 on the front of housing 1 and steam outlets on soleplate 3.

Modifications and alterations obvious to those skilled in the art are not to be considered as beyond the scope of the present intention.

What is claimed is:

1. A retractable cord assembly having a power cord for supplying power to an electrical appliance and a plug top coupled to the power cord for connecting the power cord to an electrical wall outlet, the plug top comprising a housing having electrical pins for electrical connection with electrical connectors of the electrical wall outlet and a spring-loaded spool on which the power cord can be coiled within the plug top housing, and wherein the power cord is extendable from the housing and the spring-loaded spool provides a retracting force to retract the power cord back within the housing.

2. The retractable cord assembly of claim 1 wherein the plug top further comprises a brake for maintaining the power cord in the extended position and a brake release for releasing the brake so that the retracting force retracts the power cord back within the housing.

3. The retractable cord assembly of claim 1 wherein the brake release comprises a button located on the plug top housing.

4. In a domestic appliance a retractable cord assemble retractable cord assembly having a power cord for supplying power to the domestic appliance and a plug top coupled to the power cord for connecting the power cord to an electrical wall outlet, the plug top comprising a housing having electrical pins for electrical connection with electrical connectors of the electrical wall outlet and a spring-loaded spool on which the power cord can be coiled within the plug top housing, and wherein the power cord is extendable from the housing and the spring-loaded spool provides a retracting force to retract the power cord back within the housing.
